(19) United States
(12) Patent Application Publication
(10) Pub. No.: US 2005/0234876 A1
(43) Pub. Date: Oct. 20, 2005

(54) Method of indexing into an extensible data table

(76) Inventor: William Bryson McHardy, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/813,996

(22) Filed: Mar. 30, 2004

(51) Int. Cl. G06F 7/00

(52) U.S. Cl. 707/3

(57) ABSTRACT

A method of searching a specially-constructed data table enables a data structure that emulates a multi-dimensional array, and enables data to be added to the data table without the need to revise a program that accesses the data in the table. Data elements are stored linearly in the data table in an order prescribed by nesting the indices of the emulated multi-dimensional array, and are separated by special table entries indicating index transitions. The data table is searched for an element identified by a particular set of indices by searching the table for segments corresponding to each index, most major index first.

### FIELD OF THE INVENTION

The present invention relates generally to computing.

### BACKGROUND OF THE INVENTION

In the restricted programming environment of low-level computer operating system code or firmware code, changing the size of a data table can require changes to both the data table and a program routine that extracts data from the table. Changes such as these consume programming time and present risks of programming error. There is a need for a data access method that accommodates changes in data size with little or no programming effort and with little risk of error.

### SUMMARY OF THE INVENTION

A method of searching a specially-constructed data table enables a data structure that emulates a multi-dimensional array. Data elements are stored linearly in the data table in an order prescribed by nesting the indices of the emulated multi-dimensional array, and are separated by special table entries indicating index transitions. The data table is searched for an element identified by a particular set of indices by searching the table for segments corresponding to each index, most major index first.

### BRIEF DESCRIPTION OF THE DRAWINGS

FIG. 1 shows a flowchart of a prior art low-level routine for providing cache configuration information.

FIG. 2 depicts a conceptual two-dimensional data array.

FIG. 3 depicts the data from the conceptual data array of FIG. 2 stored in a specially constructed data table in accordance with an example embodiment of the invention.

FIGS. 4A and 4B depict a flowchart of a method, in accordance with an example embodiment of the invention, for fetching data from the table of FIG. 3.

FIG. 5 depicts a conceptual two-dimensional data array in which array elements have been added in one dimension as compared with the data array of FIG. 2.

FIG. 6 shows the data from the conceptual data array of FIG. 5 stored in a specially constructed data table in accordance with an example embodiment of the invention.

FIG. 7 shows a conceptual three-dimensional array.

FIG. 8 shows a data table that stores the data in the conceptual three-dimensional array of FIG. 7 in an organization for searching in accordance with an example embodiment of the invention.

FIG. 9 shows a flowchart of a routine in accordance with an example embodiment of the invention for searching the data table of FIG. 8.

FIG. 10 shows an example data table for emulating a conceptual one-dimensional array in accordance with an example embodiment of the invention.

### DETAILED DESCRIPTION

A system for reporting microprocessor configuration information to a computer operating system provides an example application in which an embodiment of the invention finds particular utility. In a typical computer system, an operating system provides an interface between system resources and application software running on the computer. In an example computer, the operating system can obtain information, using low-level system firmware calls, about the configuration details of the computer.

For example, the computer may have various types and levels of cache memory. Cache memory is typically fast memory interposed between a computer's microprocessor registers and main memory, and stores frequently used items so that those items are accessible to the microprocessor more rapidly than if they were stored in the computer's main memory, thereby improving system performance as compared with a computer without a cache. Often, separate caches are maintained for program instructions and for data, and more than one level of cache may be provided for instructions, or data, or both. The cache levels are typically numbered progressively, for example level 0, level 1, and so forth. Each progressive cache level is typically larger and slower than the one that precedes it, but less expensive per storage unit.

The operating system in the example computer may have a need for information about the cache configuration used in the computer, for example about the parity checking applied to each cache, about cache error-correction methods, or the like. If the example computer has two levels of cache for instructions and two levels for data, the caches may be called the level 0 instruction cache, the level 1 instruction cache, the level 0 data cache, and the level 1 data cache. Programming constraints, imposed by the fact that the low-level routine for supplying the configuration information runs early in the computer's startup, may require that the routine exist and operate entirely in read only memory (ROM) and not address any of the computer's random access memory (RAM).

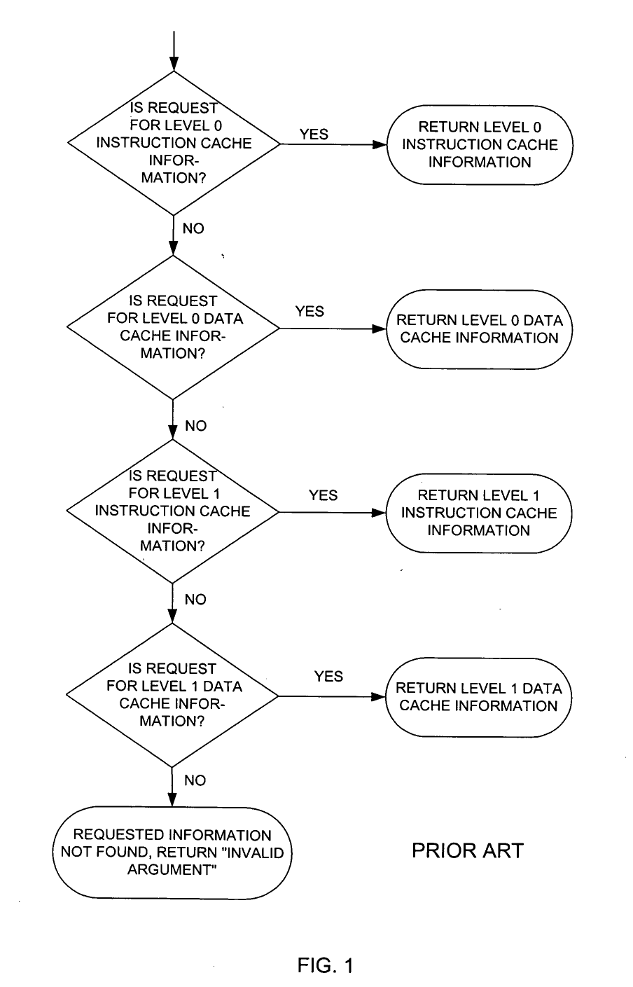

FIG. 1 shows a flowchart of a prior art low-level routine for providing cache configuration information. The routine is a simple series of comparisons and branches. If a new or different version of the microprocessor is developed having more cache levels, the low-level routine for fetching the information will have to be changed. In computer design, it is desirable to avoid code changes whenever possible so as to conserve programming time and to minimize the risk of programming errors, both of which are costly. This is especially true in low-level system programming, where routines such as that depicted in FIG. 1 may be written in assembly language.

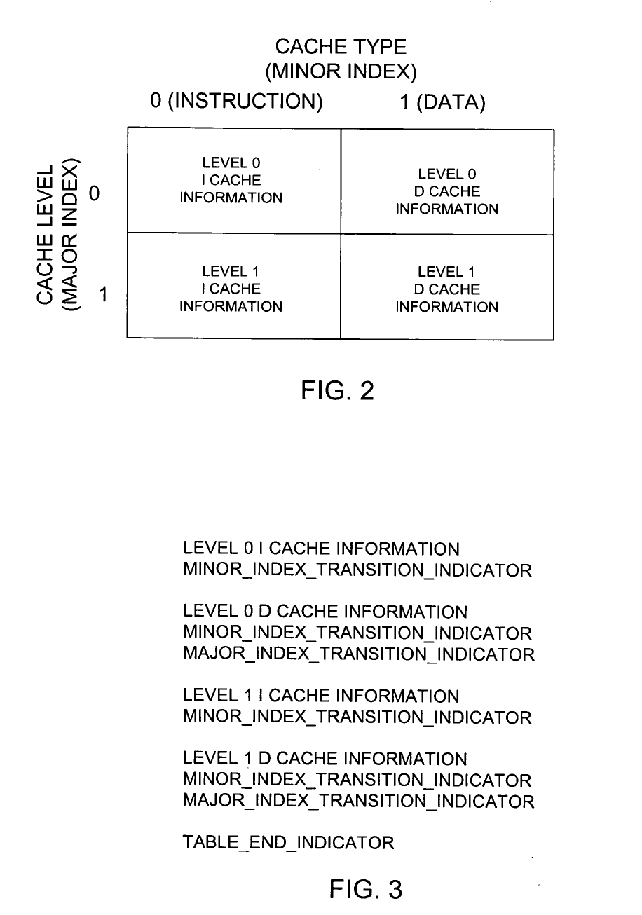

Using a method in accordance with an example embodiment of the invention, the cache configuration information is stored in a specially constructed table and the fetching routine is configured so that a change in the size of the data structure can be accommodated with a change only to the stored data, without requiring a change to the fetching routine. The configuration information can be thought of as being stored in a two-dimensional array as shown in FIG. 2. In FIG. 2, information about the level 0 instruction cache is thought of as stored in array element (0,0), information about the level 0 data cache is thought of as stored in array element (0,1), and so forth. Each element of the array is indicated by a pair of array indices (i,j), with the first index of the pair (i, indicating the cache level in this example) being the major index, and the second (j, indicating the cache type, instruction or data, in this example) being the minor index.

FIG. 3 depicts the data from the conceptual data array of FIG. 2 stored in a specially constructed data table in accordance with an example embodiment of the invention. The data are stored linearly in memory, in an order determined by nesting the indices of the conceptual array, most major index first. That is, all of the data having a major index of 0 are listed before any of the data having a major index of 1. In the example table, all data relating to level 0 caches is listed before any data relating to level 1 caches. Within the part of the table that stores data having a major index of 0, all of the data with a minor index of 0 are listed before any of the data having a minor index of 1. In the example table, data relating to instruction caches is listed before data relating to data caches.

The information relating to each cache may be of any predetermined length. For example, the level 0 instruction cache information at the first location in the table could be three eight-byte entries, for a total of 24 bytes of information.

A special entry is made in the table whenever a change of any index occurs, to indicate an index transition. Another special entry indicates that the end of the table has been reached. The special entries contain values that will not occur in the cache information, and that are arbitrarily preselected. Preferably, the index transition indicators are of a size compatible with the size of the cache information in the table. For example, if the cache information is stored in sets of eight-byte values, then it is convenient if the transition indicators are also eight-byte values so that similar data reading instructions can be used to extract them.

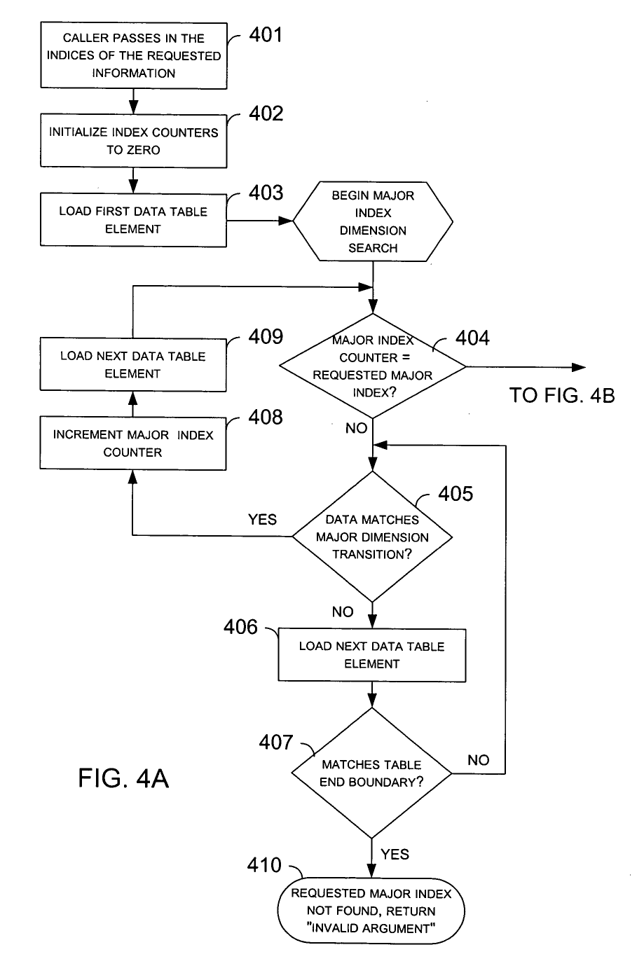

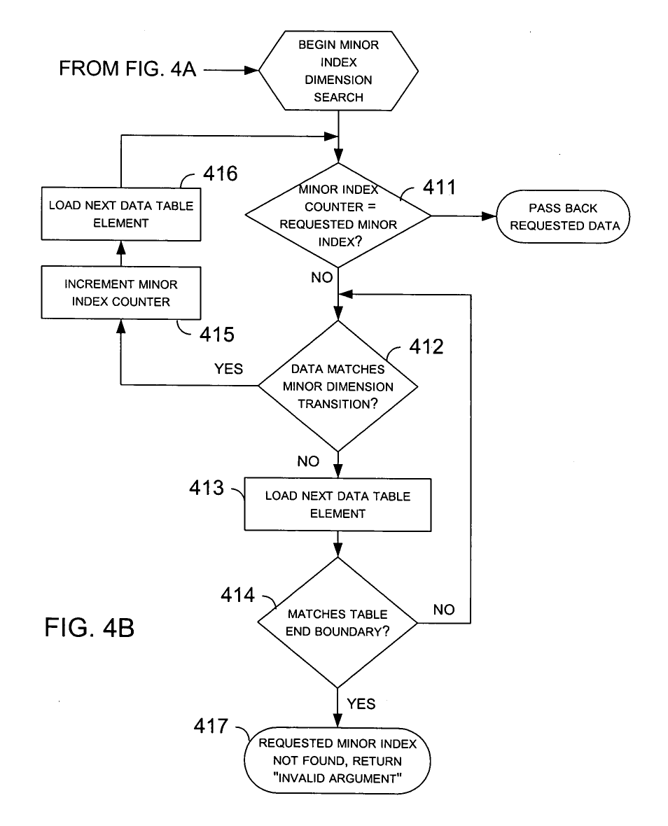

FIGS. 4A and 4B depict a flowchart of a method, in accordance with an example embodiment of the invention, for fetching data from the table of FIG. 3. In step 401, a calling routine passes the indices of the requested data to the fetching routine. The indices of the requested data are also called requesting indices, for the purposes of this disclosure. For example, in the example system, the calling routine may request information about the level 1 instruction cache, and so would pass indices (1,0) to the fetching routine. In step 402, one index counter for each dimension of the conceptual array is set to zero. In step 403, the first data element of the table is loaded. At step 404, a decision is made based on the value of the index counter corresponding to the major index. If the counter indicates that the correct major-index segment of the table has been reached, control passes to FIG. 4B. Otherwise, the data element is checked in step 405 to see if it indicates that a major dimension transition indicator has been found. If so, the counter corresponding to the major index is incremented at step 408, the next data element is loaded at step 409, and control passes again to step 404. If a major index transition indicator has not been found, the next data element is loaded at step 406, and is tested at step 407 to see if that data element is an indication that the end of the table has been reached. If the end of the table has been reached, then the calling routine has asked for data that is not in the table, and an indication is returned to the calling routine that its request was invalid. If the end of the table has not been reached, then control passes again to step 405. Thus, the flowchart of FIG. 4A depicts searching the table of FIG. 3 until the segment of the table corresponding to the correct major index is located or the end of the table is found.

Similarly, the flowchart of FIG. 4B depicts searching the table of FIG. 3 until the data corresponding to the correct minor index (in the segment with the correct major index, found by the steps depicted in FIG. 4A) is located or the end of the table is found. At step 411, a decision is made based on the value of the index counter corresponding to the minor index. If the counter indicates that the correct minor-index segment in the table has been reached, then the requested data has been found and is passed back to the calling routine. (In this two-dimensional example, the correct minor-index segment of the table is the requested data element.) Otherwise, the data element is checked in step 412 to see if it indicates that a minor dimension transition indicator has been found. If so, the counter corresponding to the minor index is incremented at step 415, the next data element is loaded at step 416, and control passes again to step 411. If a minor index transition indicator has not been found, the next data element is loaded at step 413, and is tested at step 414 to see if that data element is an indication that the end of the table has been reached. If the end of the table has been reached, then the calling routine has asked for data that is not in the table, and an indication is returned to the calling routine that its request was invalid. If the end of the table has not been reached, then control passes again to step 412.

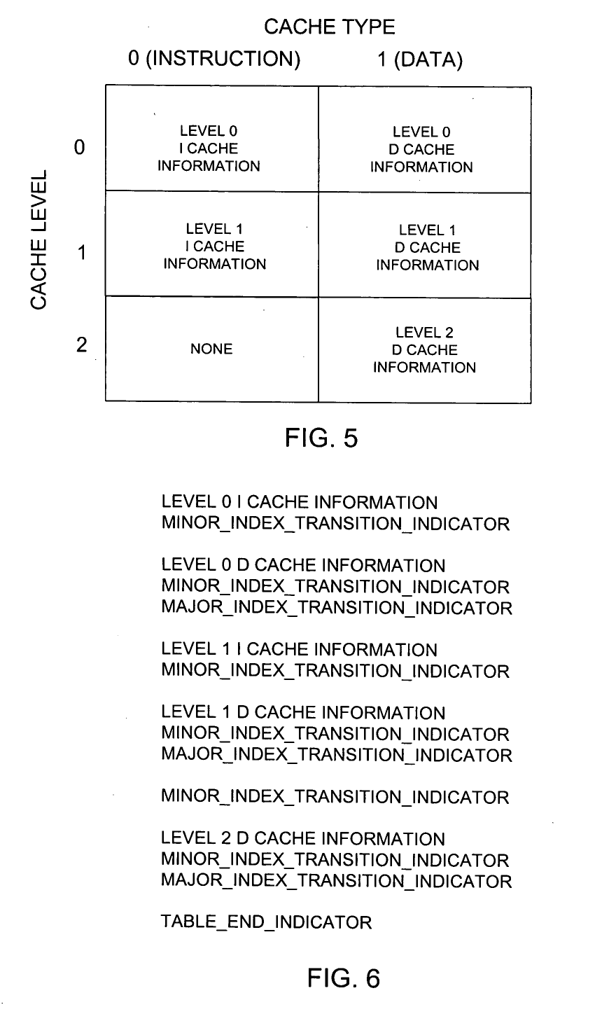

The utility of the method is especially apparent when it is desired to change the size of the table of FIG. 3. For example, the example computer may be modified, so that another level of data cache, level 2, is available. Or a new computer system may be developed that uses much of the same architecture and firmware as the example computer, but that has an additional cache level. FIG. 5 depicts a conceptual two-dimensional array representation of cache configuration information for the modified computer. The conceptual array still has two dimensions, and thus two indices are sufficient to address its contents, but the array is now larger than the array of FIG. 2.

In a method in accordance with an embodiment of the invention, only the table of FIG. 3 is modified to accommodate the new computer feature. FIG. 6 shows the modified table. In fetching data, including the new data, from the data of FIG. 6, the steps of FIGS. 4A and 4B can be performed exactly as they were in the case of the smaller data table. No changes need be made to the data fetching routine, and thus programming time is conserved and opportunities for programming errors are avoided.

While a routine for returning cache configuration information provides an example application in which the invention may be embodied, the method may be used in other applications as well. For example, other low-level information routines in a computer may embody the method and return information about the processor's register structure, information about the computer's translation lookaside buffer (TLB), or about other hardware components. Furthermore, the application of the method is not limited to low-level computer configuration routines. The method may find general applicability for accessing any data set that may conceptually be organized into an array, and is especially applicable where the size of the data set may change.

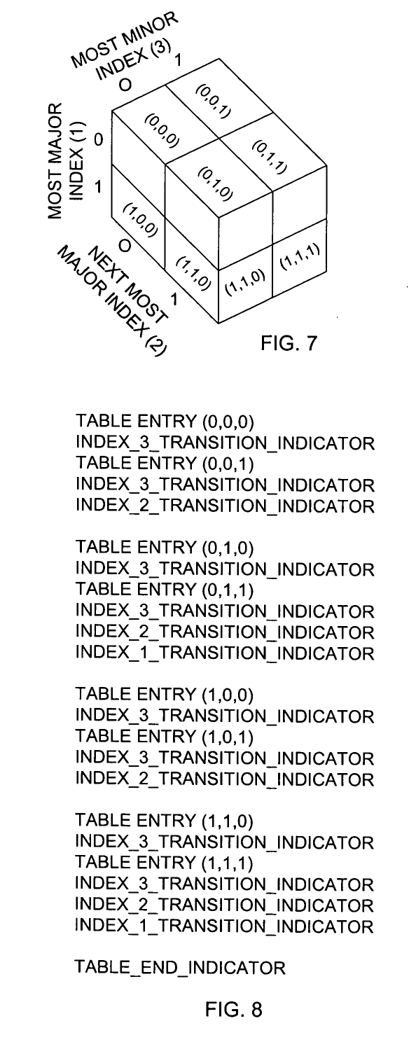

A further advantage of the method is the relative ease with which it may be adapted when an additional dimension is added to the data set. The example implementation shown in FIGS. 2 through 6 uses a data set that can be conceptualized as having two dimensions, and where data was added such that the data set still had two dimensions, with one of the dimensions being changed. FIG. 7 shows a conceptual three-dimensional array, and FIG. 8 shows a data table that stores the data in the conceptual three-dimensional array in an organization for searching in accordance with an example embodiment of the invention. In the table of FIG. 8, the order of the elements is prescribed by nesting their indices from the conceptual array of FIG. 7. That is, all of the elements with a major index of 0 are listed before any elements with a major index of 1. Within those two major segments, all elements with a next most major index of 0 are listed before any element with a next most major index of 1. Within those four segments, elements with a most minor index of 0 are listed before elements with a most minor index of 1. In this three-dimensional example, index transition indications are numbered, with the most major index transition being numbered 1 and the most minor index transition being numbered 3. Entries in the data table are simply called “table entries”, rather than “cache information” as in FIGS. 3 and 6.

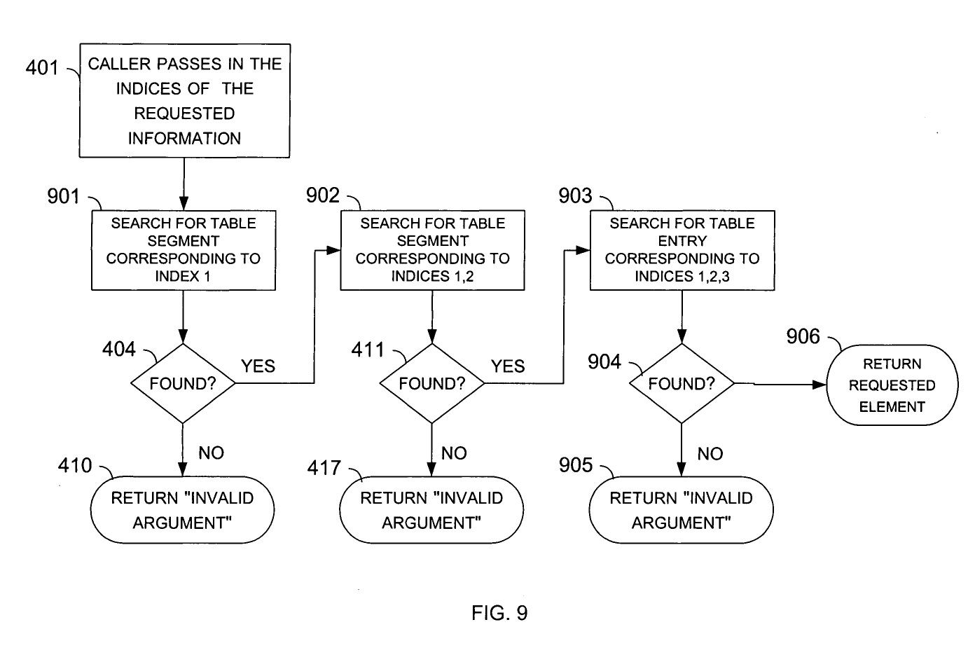

A data-fetching routine for indexing into the table of FIG. 8 is easily constructed by extending the routine shown by flowchart in FIGS. 4A and 4B. Such a routine is depicted in flowchart form in FIG. 9. In FIG. 9, several steps shown separately in FIGS. 4A and 4B have been consolidated. The flowchart of FIG. 4A is shown by steps 401, 901, 404, and 410 of FIG. 9. Similarly, the flowchart of FIG. 4B is shown by steps 902, 411, and 417 of FIG. 9. The flowchart of FIG. 9 adds steps 903, 904, and 905, which provide a search in the third dimension of the conceptual three-dimensional array of FIG. 7. A programmer who wishes to add a dimension to a data structure in accordance with an embodiment of the invention need only construct the data table and copy a section of code corresponding to a search of an existing dimension, making only minor changes to accommodate the added dimension. Each code section provides searching for the table segment corresponding to a particular requesting index, also called the current index for that code section. Programming time is conserved because much of the required code is copied from an existing routine, and opportunities for programming errors are minimal because the changes to the copied code are few. Other dimensions can be added to the data structure in a similar manner as desired.

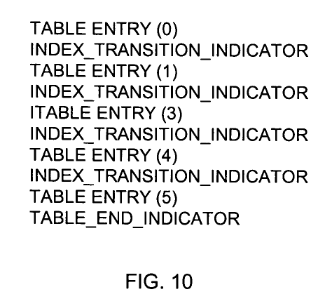

In another example embodiment, the emulated conceptual array is one-dimensional. In emulating a conceptual one-dimensional array, data elements are arranged linearly in a data table, separated by index transition indicators. An additional indicator marks the end of the data table. FIG. 10 shows an example data table for emulating a conceptual one-dimensional array in accordance with an example embodiment of the invention. The conceptual array emulated by the table of FIG. 10 has five elements. FIG. 4A serves as a representation of a flowchart of a method for fetching data from the table of FIG. 10 with the modification that the indication “TO FIG. 4B” need only be replaced with a terminator block indicating that the requested data is passed back to the calling routine. Of course, in a one-dimensional array, the only index is the major index.

In still another example embodiment, a computer is programmed to perform the method. The computer program that instructs the computer to perform the method may be stored in any of a variety of computer-readable media. For example, the computer program may be encoded on a magnetic disk. The magnetic disk may be a hard disk wherein data is encoded in magnetic particles adhering to a relatively rigid, usually metallic, substrate disk, or may be a floppy disk wherein data is encoded in magnetic particles adhering to a relatively flexible substrate disk usually made of plastic. Alternatively, the computer program may be encoded in a read only memory (ROM). A ROM is typically semiconductor memory that is randomly accessible, and in which the contents of the memory do not change when power is removed. The computer program may be encoded in a random access memory (RAM). A RAM is typically semiconductor memory that is randomly accessible, and in which the contents of the memory are lost when power is removed. The computer program may be encoded on an optical disk. An optical disk is typically a semi-rigid, usually plastic, substrate disk comprising a layer that encodes data by way of small areas that reflect light in at least two different ways. Examples of optical disks include the compact disk read only memory (CD-ROM), the digital versatile disk (DVD), and magneto-optic disks. Other kinds of computer-readable media may be used as well..

1. A method, comprising:
receiving a set of requesting indices identifying an element to be located in a data table, the data table linearly storing elements of a conceptual multi-dimensional data array, their order prescribed by nesting indices corresponding to dimensions of the emulated array, the entries in the data table being separated by special table entries that indicate index transitions;
searching for a segment of the data table corresponding to the most major of the requesting indices; and
searching, within the segment of the data table corresponding to the most major of the requesting indices, for a segment of the data table corresponding to the second most major of the requesting indices.

2. The method of claim 1, wherein searching for a segment of the table corresponding to one of the requesting indices comprises counting occurrences of the special table entries indicating transitions of that index.

3. The method of claim 1 wherein the conceptual array has two dimensions, and the segment of the data table corresponding to the second most major of the requesting indices is the element to be located in the data table.

4. The method of claim 1, further comprising searching, within the table segment corresponding to the second most major of the requesting indices, for a table segment corresponding to the third most major of the requesting indices.

5. The method of claim 4, wherein the conceptual array has three dimensions, and the segment of the data table corresponding to the third most major of the requesting indices is the element to be located in the data table.

6. The method of claim 1, further comprising for each succeedingly more minor index, searching, within the segment corresponding to the immediately more major index, a table segment corresponding to the current index.

7. The method of claim 6, wherein the table element corresponding to the most minor index is the element to be located in the data table.

8. The method of claim 1, wherein the data table comprises a table end indicator at the end of the data table.

9. The method of claim 8, further comprising returning an indication that the requesting indices were invalid when the table end indicator is encountered during searching.

10. The method of claim 1, further comprising passing the requested element data back to a calling routine.

11. A method, comprising:
receiving a requesting index identifying an element to be located in a data table, the data table linearly storing elements of a conceptual one-dimensional data array, the entries in the data table being separated by special table entries that indicate index transitions; and
searching for an element of the data table corresponding to the requesting index.

12. The method of claim 11 wherein searching for the element of the table corresponding to the requesting index comprises counting the special table entries that indicate index transitions.

13. A computer, programmed to perform the method of claim 1.

14. A computer, programmed to perform the method of claim 11.

15. A computer-readable medium encoded with a computer program that performs the method of claim 1.

16. The computer-readable medium of claim 15 wherein the computer-readable medium is a magnetic disk.

17. The computer-readable medium of claim 15 wherein the computer-readable medium is a read only memory.

18. The computer-readable medium of claim 15 wherein the computer-readable medium is a random access memory.

19. The computer-readable medium of claim 15 wherein the computer-readable medium is an optical disk.

20. A computer-readable medium encoded with a computer program that performs the method of claim 11.
